(19) United States
(12) Patent Application Publication
(10) Pub. No.: US 2013/0170832 A1
(43) Pub. Date: Jul. 4, 2013

(54) SWITCHING DEVICE

(71) Applicant: Yuji TOCHIO, Yokohama (JP)

(72) Inventor: Yuji TOCHIO, Yokohama (JP)

(73) Assignee: FUJITSU LIMITED, Kawasaki-shi (JP)

(21) Appl. No.: 13/614,192

(22) Filed: Sep. 13, 2012

(30) Foreign Application Priority Data
Dec. 28, 2011 (JP) 2011-289701

(51) Int. Cl. H04L 12/56; H04J 14/00

(52) U.S. Cl. 398/45; 370/401

(57) ABSTRACT

A conventional edge device is constituted of a switching device and a transmission device. The switching device determines an ODU as an accommodation destination for an L2 packet from a client side device in accordance with an L2 ID, and outputs the L2 packet to an output port to which the ODU is associated. The transmission device receives an L2 packet through an input port corresponding to an output port of the switching device in a one-to-one manner, and performs transparent mapping on the corresponding ODU so as to output the signal by using an ODU connection.

### CROSS-REFERENCE TO RELATED APPLICATION

This application is based upon and claims the benefit of priority of the prior Japanese Patent Application No. 2011-289701, filed on Dec. 28, 2011, the entire contents of which are incorporated herein by reference.

### FIELD

The embodiments described herein are related to a switching device.

### BACKGROUND

FIGS. 1 and 2 explain a conventional technique.

In order to respond to increases in Internet traffic in recent years, it has become necessary to increase the bandwidths for networks that receive direct accesses from users.

Meanwhile, a function of aggregating network services (such as Ethernet, TDM, and the like) to be provided to users has become important in order to realize accommodation of traffic from access networks to metropolitan networks or core networks. This is because aggregation is expected to reduce the man hours that have to be managed in core sections.

As illustrated in FIG. 1, a plurality of accesses are aggregated so as to handle them as a single line, and the receiver side grooms them as necessary so as to transmit data to respective transmission destinations. Thereby, in sections after the aggregation and before the grooming, it is not necessary to handle a plurality of accesses separately, making it possible to handle them as a single line. This can save hardware configurations for managing lines, and can also reduce the number of processes.

As a method of realizing the aggregation of network services in core/metropolitan areas, a method based on an ODU (Optical Data Unit) aggregation defined by ITU-T G.709 is possible. In G.709 ODU, there are a wide variety of aggregation definitions, the definitions of ODUflex, which operates in units of 1.25 G, have also been introduced, and the flexibility of aggregation has also been realized, achieving accommodation of various services.

The protocol expansion of GMPLS (Generalized Multi-Protocol Label Switching) has enabled end-to-end on a control plane, i.e., it has enabled setting, through a core network, lines of a packet network defined in a metropolitan network, and also the setting processes can be automated. Accordingly, it is expected that introduction of networks in this configuration will be accelerated.

As illustrated in FIG. 2, as the layering of a control plane, layer N defines a connection based on calling of clients, and configures a network as, for example, an Ethernet network. Layer N−1 defines a connection between servers existing between client connections, and a network based on SDH (Synchronous Digital Hierarchy) is configured. Further, layer N−2 defines a connection between servers existing between connections based on layer N−1, and defines a network based on, for example, an OTN (Optical Transport Network). As has been described above, by configuring the control plane hierarchically and defining different connections for respective layers, communications covering different networks can be provided to clients.

As a conventional example, there is a technique by which client signals of a plurality of types are mapped into a particular signal format, path switching is performed on the particular-format signals in units of time-division multiplex signals, the signals that have received path switching are mapped into a signal format appropriate to the transmission, and those signals are transmitted.
Patent Document 1: Japanese Laid-open Patent Publication No. 2008-113344

FIG. 3 illustrate a problem in a conventional technique.

When lines defined in a packet network are to be accommodated by an ODU, an ODU edge device performs a process of sorting ODUk accommodation destinations in accordance with information (identification by an identifier, a VLAN (Virtual LAN) value, or MPLS (Multi-Protocol Label Switching)) of packet lines for aggregation because the layers are of different types. The load of the sorting process is problematic.

It is also possible to accommodate communications to ODUk by using a GFP-F (Frame mapped Generic Framing Procedure). However, processes in units of packets (such as HEC (Header Error Control) and the like) are necessary in order to be compatible with GFP-F, which also increases the load.

As illustrated in FIG. 3(a), a plurality of packet lines are bundled, and are transferred by using an LO ODU (Lower Order ODU) and an HO ODU (Higher Order ODU), which increases processes for aggregating and grooming the packet lines.

FIG. 3(b) illustrates a case of GFP-F mapping. The transmitter side edge device performs L2 (layer 2) (path) determination from a client signal, determines the output destination, performs switching, and performs an aggregation GFP process. The receiver side edge device performs GFP L2 grooming from the ODU, determines the output destination, performs switching, performs port aggregation, and transmits the signal to the access network of the client.

As described above, there is a demand for a reduction in the load imposed on so-called edge devices when lines defined by so-called packet networks defined by Ethernet or MPLS are bundled to be aggregated into an OTN.

### SUMMARY

A switching device according to one aspect of the following embodiments is a switching device connected to a transmission device that aggregates lines on a client layer into lines on a server layer so as to transmit the aggregated lines, including a switching unit to switch a packet of the lines on the client layer to an output port to which each line on the server layer is associated, and to output the packet to the transmission device, in accordance with a line identifier of the line on the client layer.

According to the following embodiments, it is possible to provide a switching device that can reduce the load of aggregated transmission.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 explains a conventional technique (first);

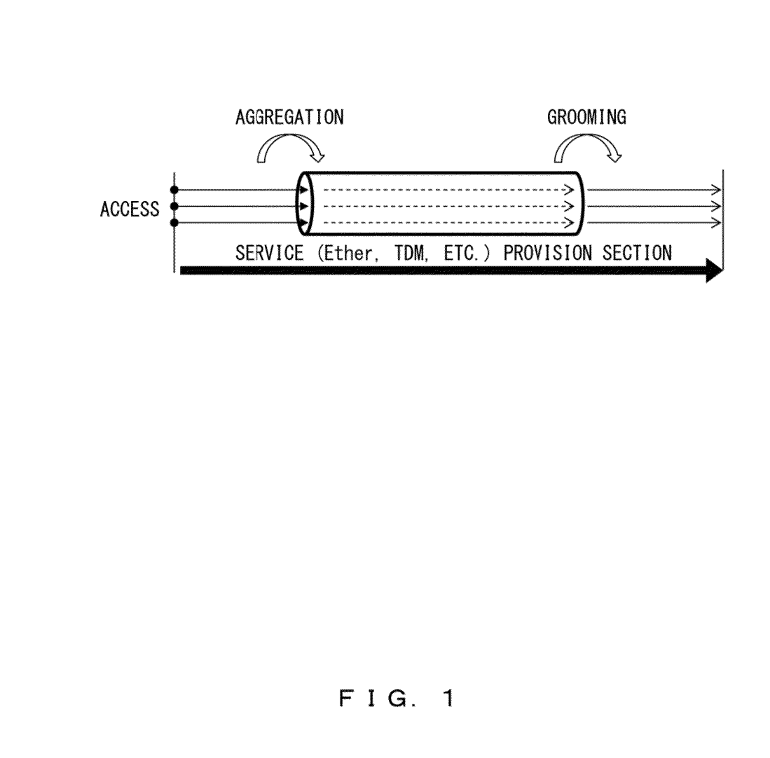

FIG. 2 explains the conventional technique (second);

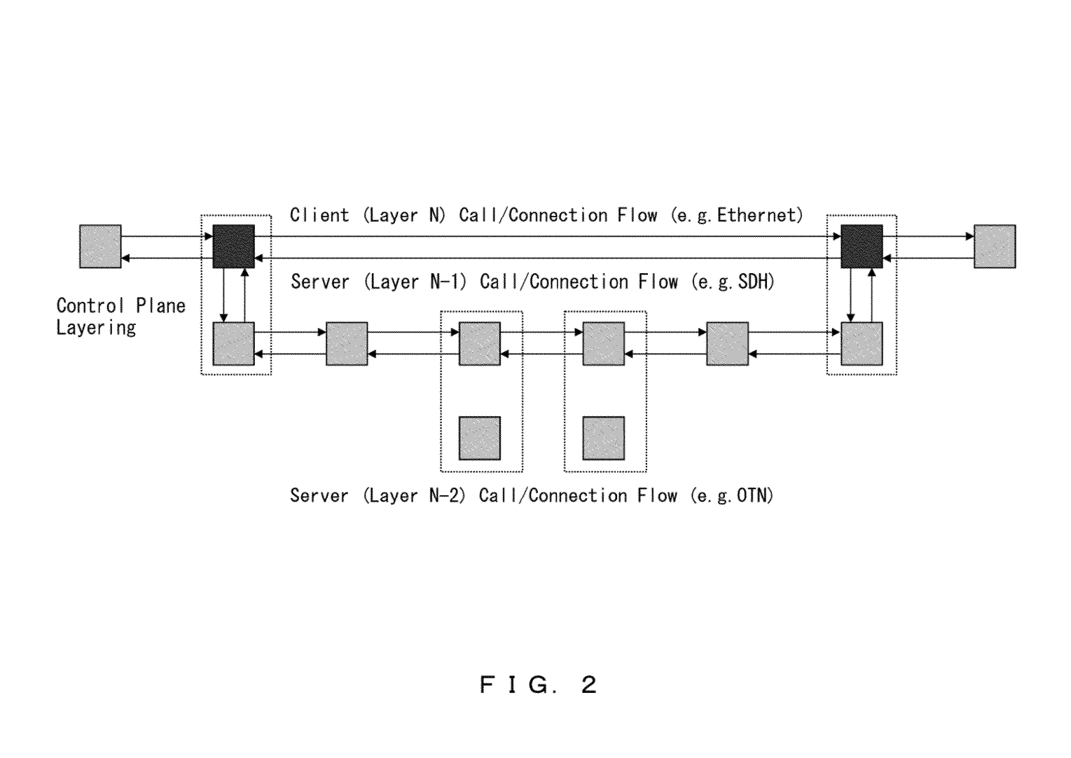

FIG. 3 explains a problem of the conventional technique;

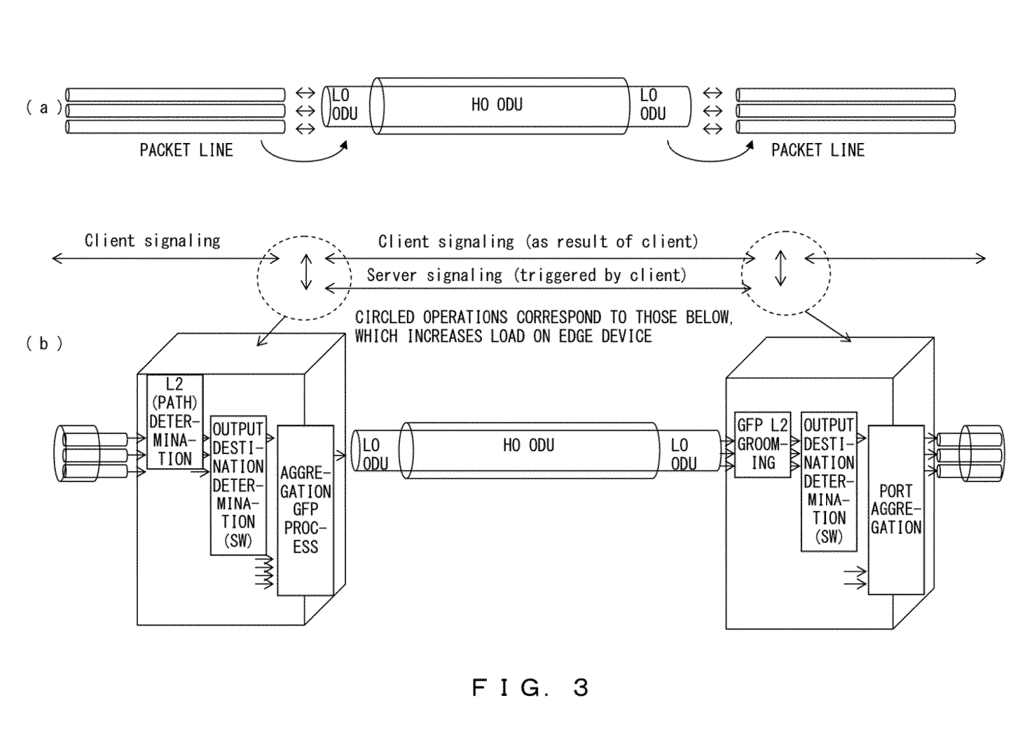

FIG. 4 explains a present embodiment (first);

FIG. 5 explains the present embodiment (second);

FIG. 6 explains the present embodiment (third);

FIG. 7 explains the present embodiment (fourth);

FIG. 8 explains the present embodiment (fifth);

FIG. 9 explains the present embodiment (sixth);

FIG. 10 explains an example of another configuration of the present embodiment;

FIG. 11 explains an example of still another configuration of the present embodiment; and

FIG. 12 illustrates a comparison of configurations between the conventional technique and the present embodiment.

### DESCRIPTION OF EMBODIMENTS

According to the present embodiment, lines defined by a so-called packet network defined by Ethernet or MPLS are bundled, and are aggregated into an OTN.

In particular, according to the present embodiment, a switching device that constitutes part of a configuration corresponding to an OTN edge device for reducing the process load on an OTN edge device is illustrated. In other words, this switching device and a transmission device (which will be explained) constitute an OTN edge device.

Specifically, attention is paid to the fact that an (LO) ODU is basically applied to site-to-site connection and that the Ethernet accommodation can be realized both in the frame basis and the port basis. Also, a portion of the setting information of an edge node (=switching information) obtained when end-to-end setting is performed is transplanted locally (i.e., as a neighboring relationship having nothing to do with GMPLS protocol) to a neighboring transmission device, and the transmission device adjusts the packet traffic so that it can be accommodated by an ODU.

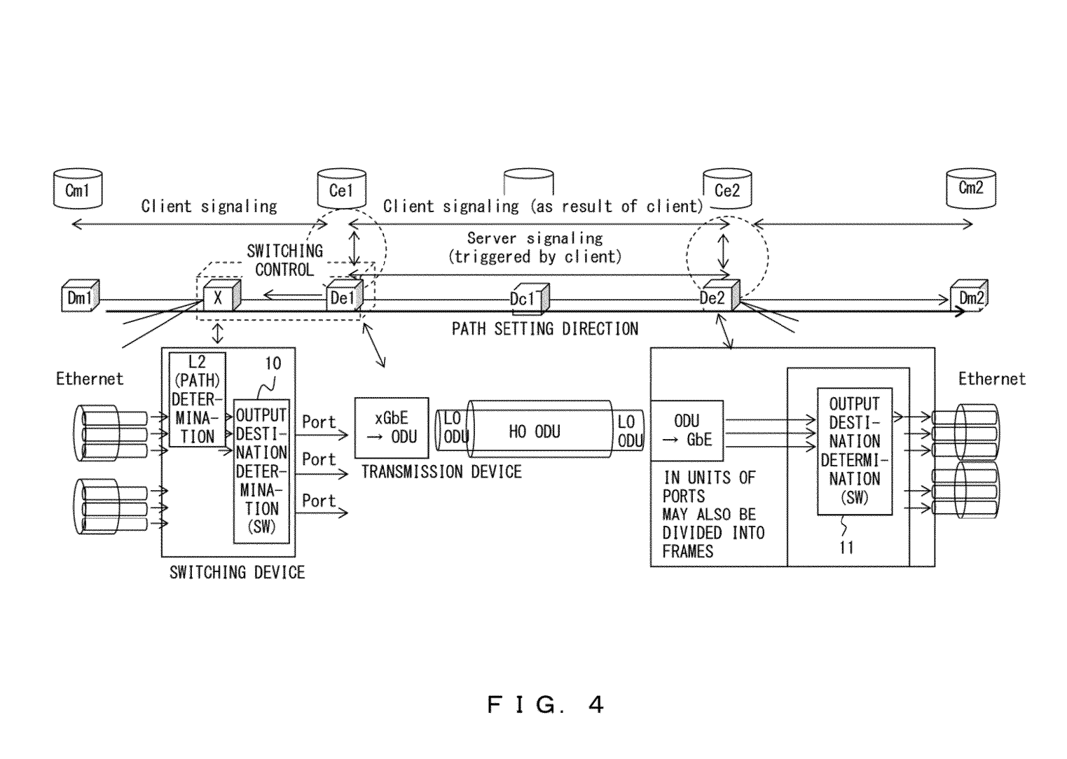

FIGS. 4 through 9 explain the present embodiment.

FIG. 4 illustrates a case where GMPLS has been used for the end-to-end lines, and the path setting direction is from left to right.

Switching device X illustrated in FIG. 4 is a device that does not depend upon a C-plane (Control-plane), while other devices (Dm1, Dm2, De1, De2, and Dc1) do depend upon a C-plane. Also, devices corresponding to a C-plane, i.e., devices Cm1, . . . , that can perform GMPLS protocol (routing and signaling) operations are provided. “Depend upon a C-plane” indicates that functions for performing operations in accordance with the IP used by a C-plane for signaling and routing are included.

Also, switching device X employs a configuration in which several GbEs (or GbEs such as 10 GbE) are connected parallelly, and switching device X is connected to devices such as Dm1 or the like on the client side through arbitrary ports. GbEs are Ethernet ports in the Gigabit class.

On the lower side in FIG. 4, switching device X has an output destination determination unit 10 that performs L2 determination on signals on the client side, and performs switching after determining the output determination. Ports associated to ODUs are provided to output destinations of the switching. Transmission device De1 maps, into an ODU, a GbE signal input from an input port in order to transfer signals to the ODUs corresponding to the input ports. Connection between switching device X and transmission device De1 is only for connecting, in a one-to-one manner, an output port of switching device X to an aggregation unit that performs mapping into the corresponding ODUs.

Transmission device De2 on the receiver side grooms a signal received from the ODU into GbE signals, and outputs the signals through output ports corresponding to the ODUs. Grooming may be performed in units of ports or in units of frames.

After the grooming process, an output destination determination unit 11 determines a transmission destination for each port, and transfers the signals to device Dm2 on the client side after performing a switching process.

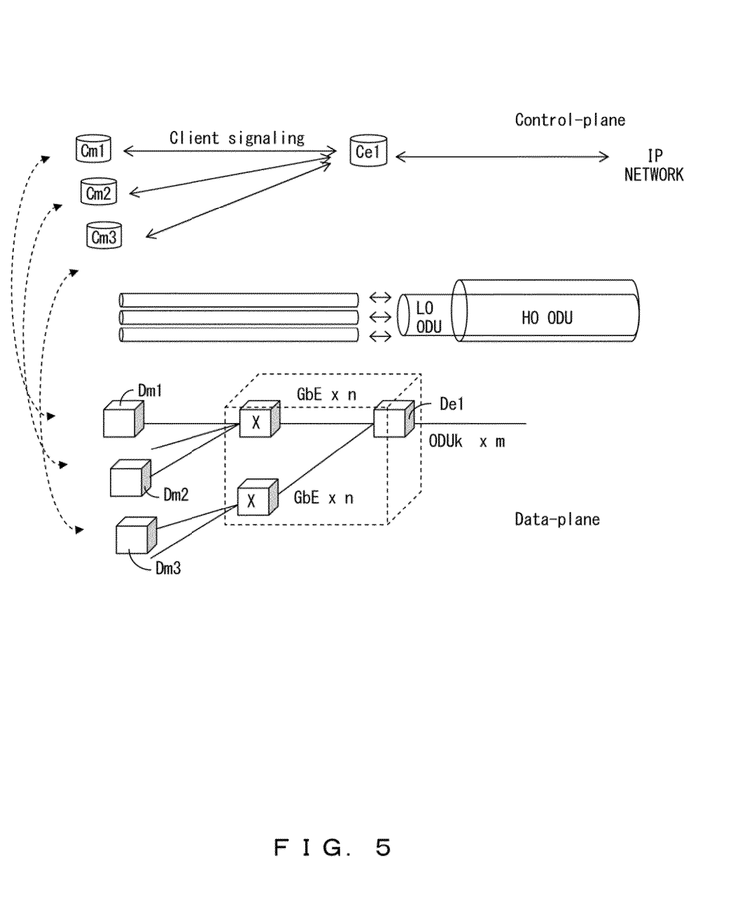

As illustrated in FIG. 5, switching devices X are arranged in a star configuration in an edge device, and there is a logical adjacency relationship between Cmx and Ce1, on the IP network, and thus the routing/signaling information is not influenced. Note that, in FIG. 5, client side devices Cm1 through Cm3 and transmission device Ce1 represent devices on a C-plane, and devices Dm1 through Dm3, switching device X, and transmission device De1 represent devices on a Data-plane. Cm1 through Cm3 and Dm1 through Dm3 correspond to each other as indicated by dashed arrows, while switching device X is a device that does not depend upon a C-plane, and thus it is not displayed on a C-plane.

In other words, on the IP network (C-plane), devices Cm1 through Cm3 are connected to device Ce1 in a tree structure. Accordingly, when path formation is performed on the basis of signaling on a C-plane, correspondence between the device configuration on a C-plane and that on a Data-plane is necessary for realizing the path on a Data-plane. In order to maintain this tree structured connection, a plurality of switching devices X are connected in a tree structure to transmission device De1, which is connected to an ODU, so that client side devices Dm1 through Dm3 are connected in a tree structure to switching devices X. Thereby, switching devices X, transmission device De1, and client side devices Dm1 through Dm3 are connected while maintaining the connection relationship in an IP network, and accordingly all connections established by the signaling of an IP network can be established by physical devices.

According to the setting of GMPLS, signaling is performed while coordinating clients (packet lines) and servers (ODU lines), and thus the relationship between packet input port/line information and an output ODU is established. However, according to the present embodiment, OTN packet input ports are handled as GbE lines (physical Ethernet port) such as GbE or the like, and an L2 process is passed over to switching devices X illustrated in FIG. 4.

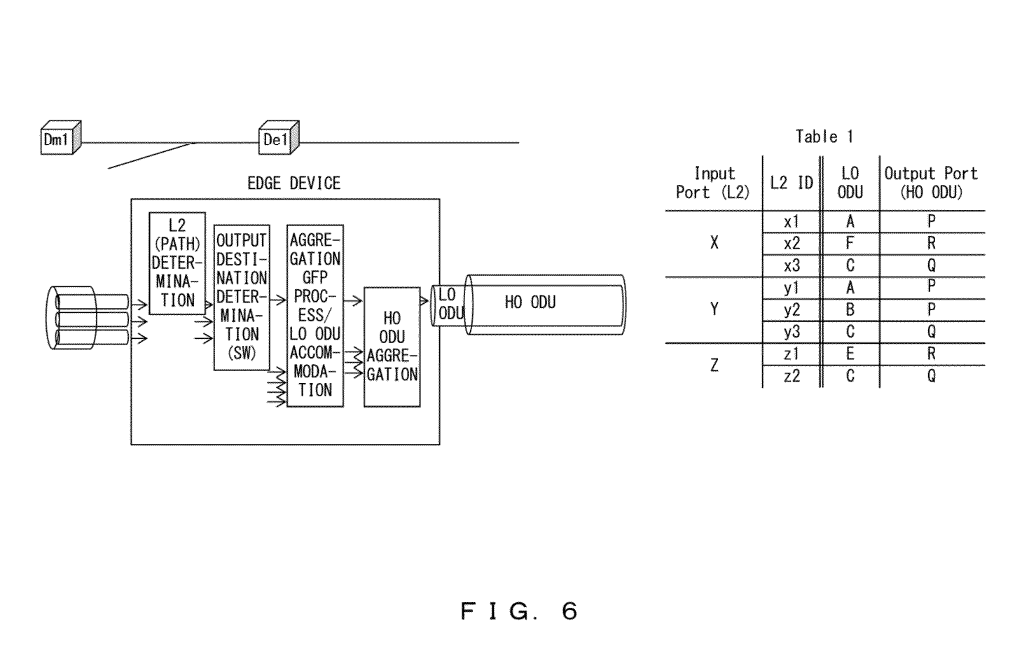

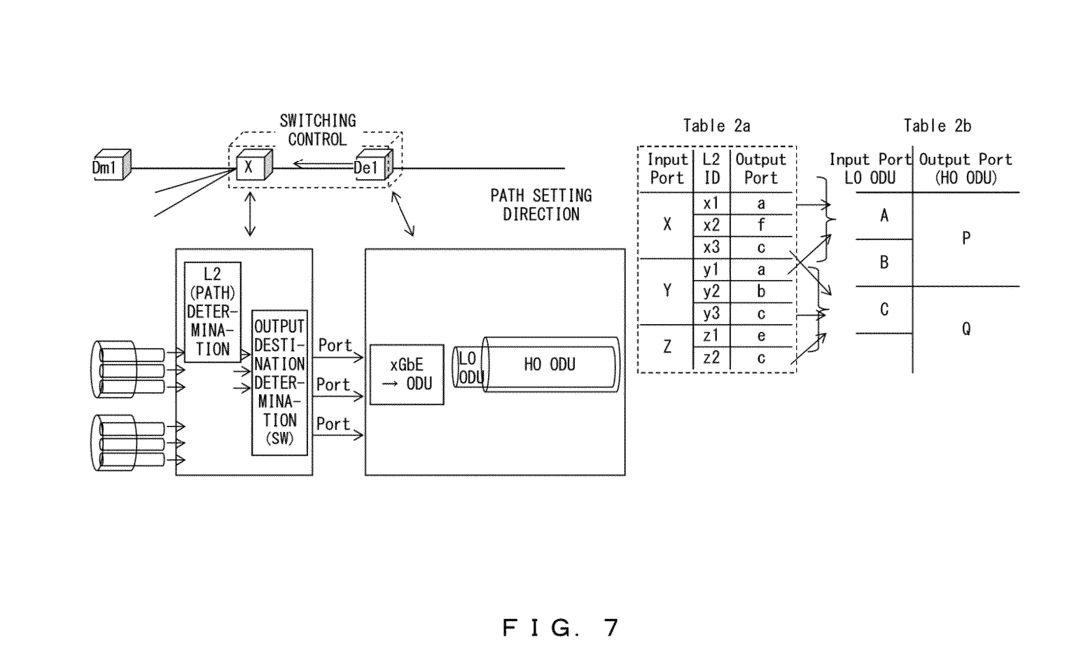

FIGS. 6 and 7 illustrate input/output tables of a conventional technique and the present embodiment, respectively.

FIG. 6 illustrates a conventional input/output table. In conventional techniques, mapping of a table 1 was conducted in an edge device. On the table 1, a plurality of L2 IDs (identifiers) are associated with each of the input ports from client side devices. In order to sort them to ODUs, which of the LO ODUs the mapping is to be directed to is determined for each L2 ID, and an output port for aggregation to an HO ODU is assigned for each LO ODU.

FIG. 7 is an input/output table according to the present embodiment. In FIG. 7, a table 2a is held by switching device X, and a table 2b is held by a transmission device De1. On the table 2a, a plurality of L2 IDs are associated with each of the input ports from client side devices. Further, for each of the L2 IDs, which of the output ports data is to be output to is defined. Each of the output ports is associated with an LO ODU. Which of the LO ODUs the mapping is directed to is determined on the basis of which of the output ports output is made through. On the table 2b, an output port corresponding to an HO ODU is associated with an input port of an LO ODU that is associated with an output port of the switching device X in a one-to-one manner. The relationship between the tables 2a and 2b is based on transparent mapping.

In FIG. 6 HO ODUs are associated with the respective L2 IDs, while in FIG. 7, HO ODUs are associated with the input ports of transmission device De1. In FIG. 7, mapping from an L2 ID into an LO ODU is performed on the basis of which of the output ports the switching device X outputs signals through. Accordingly, as illustrated in the table 2b, transmission device De1 only has to map, into an HO ODU, a signal from an input port that has already been mapped into an LO ODU, which reduces the data amount.

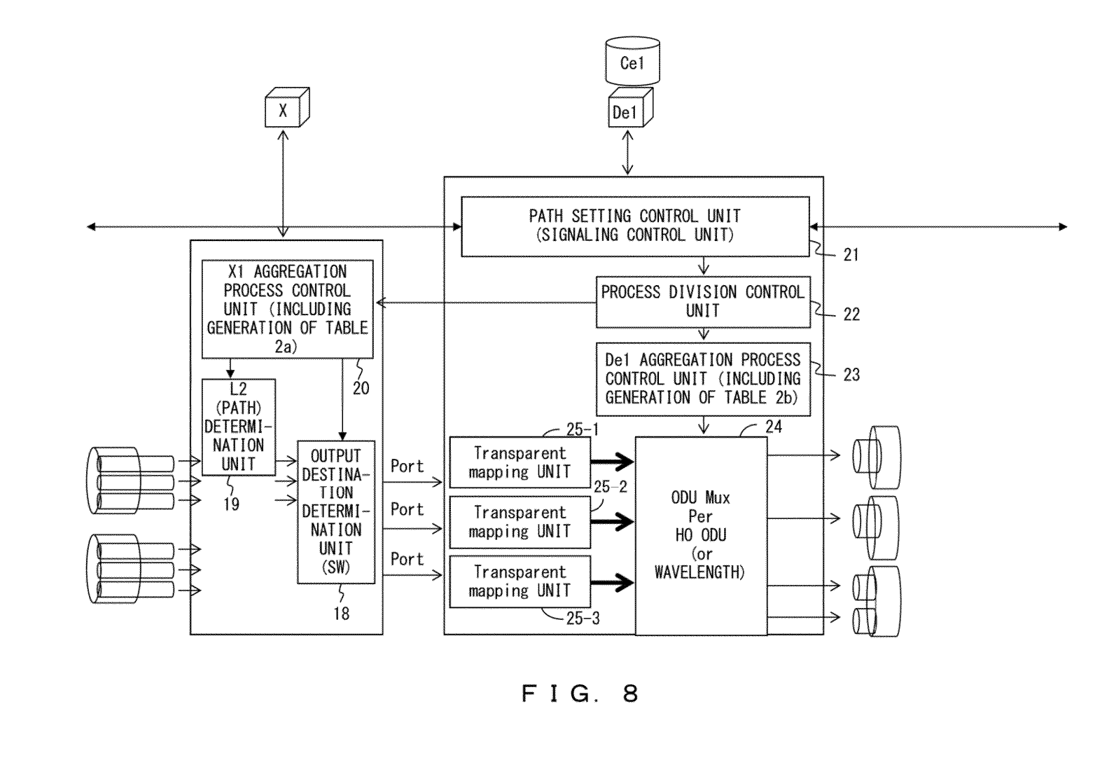

FIG. 8 illustrates configurations of a switching device and a transmission device.

Switching device X is provided with an L2 (Path) determination unit 19, an output destination determination unit 18 serving as a switch, and an X1 aggregation process control unit 20. The X1 aggregation process control unit 20 holds the table 2a illustrated in FIG. 7, and performs, in accordance with the L2 IDs of input signals, a switching process on the signals in order to output the signals to output ports corresponding to the LO ODUs that are to accommodate these signals. The X1 aggregation process control unit 20 controls the L2 determination unit 19, and the output destination determination unit 18.

Transmission device De1 is provided with a path setting control unit (signaling control unit) 21, a process division control unit 22, a De1 aggregation process control unit 23, an ODU Mux 24, and transparent mapping units 25-1 through 25-3. The path setting control unit 21 controls signaling, and controls the path setting between client devices. The process division control unit 22 assigns, to switching device X and transmission device De1, associations between L2 IDs and LO ODUs, which are to be performed by the switching device X, and associations between LO ODUs and HO ODUs, which are to be performed by transmission device De1, among signaling processes. The De1 aggregation process control unit 23 holds the table 2b in FIG. 7, controls the ODU Mux 24, and aggregates, into an HO ODU, signals input from an input port corresponding to an LO ODU. The transparent mapping units 25-1 through 25-3 perform mapping on frames from input ports into LO ODUs in units of bits or bytes as they are, i.e., without performing a process of exchanging frames, and transfers the signals to an input port of the ODU Mux 24. Transparent mapping is a process of including data of input frames into payloads of other frames directly, while ordinary mapping solves frames, and reassemble them into different frames by referring to the header information. As described above, including data directly into payloads without referring to the original frames is referred to as mapping in units of bits or bytes. The ODU Mux 24 aggregates input LO ODUs in units of HO ODUs or wavelengths.

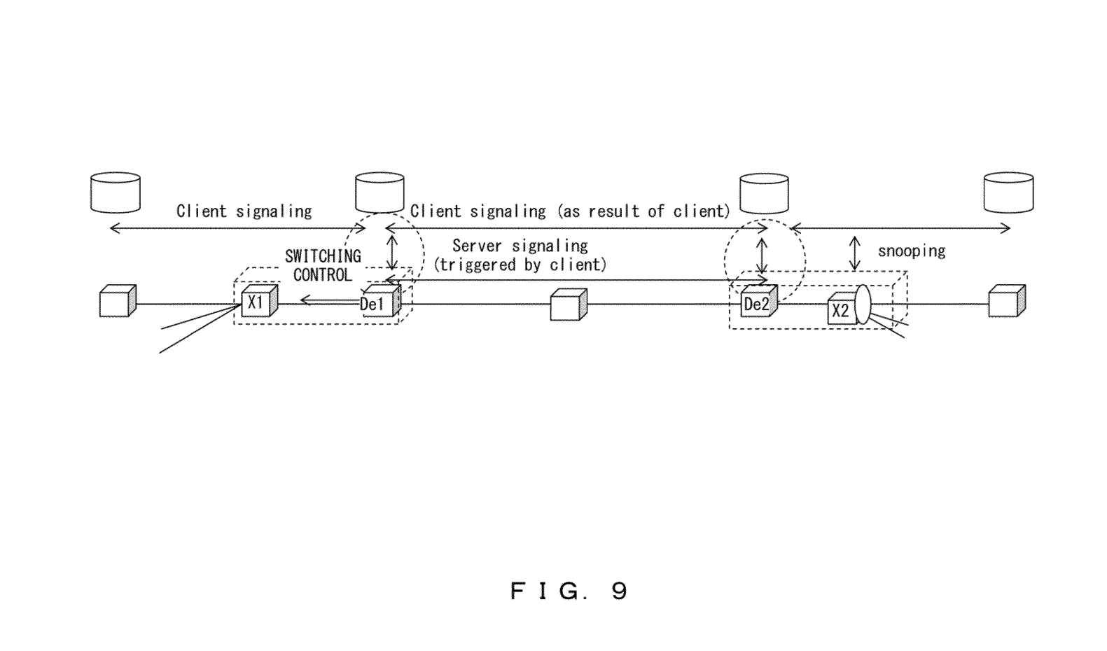

The processes in OTN edge device De2 (FIG. 4) can be implemented by Demux using L2 as in conventional techniques, and devices corresponding to switching device X are not necessary. However, it is also possible to provide switching device X2 in addition to switching device X1 as illustrated in FIG. 9, taking into consideration the symmetry of the upper and lower lines of devices.

In FIG. 9, if signals are transferred from left to right, switching device X1 and transmission device De1 on the transmitter side operate as described above. However, transmission device De2 on the receiver side performs Demux in units of L2. Switching device X2 on the receiver side only refers to the configuration of packets, and performs a process of transferring the packet (snooping) without performing direct processes.

Also, not only Ethernet but also an LSP such as MPLS may also be applied as a client side network. Specifically, an L2 ID corresponds to labels on the table 2a illustrated in FIG. 7, and other processes become equivalent.

In the present embodiment, a configuration in which switching device X and client side device Dm1 are directly connected via a port such as ODUO GbE, and a plurality of L paths that are bundled to the OTN edge device (transmission device De1) are accommodated as an actual implement. However, it is also possible to implement a configuration in which the actual connection is based on xGbE (a rate that cannot be accommodated directly by ODU0, 2(e), 3, 4, such as 5 GbE, or the like).

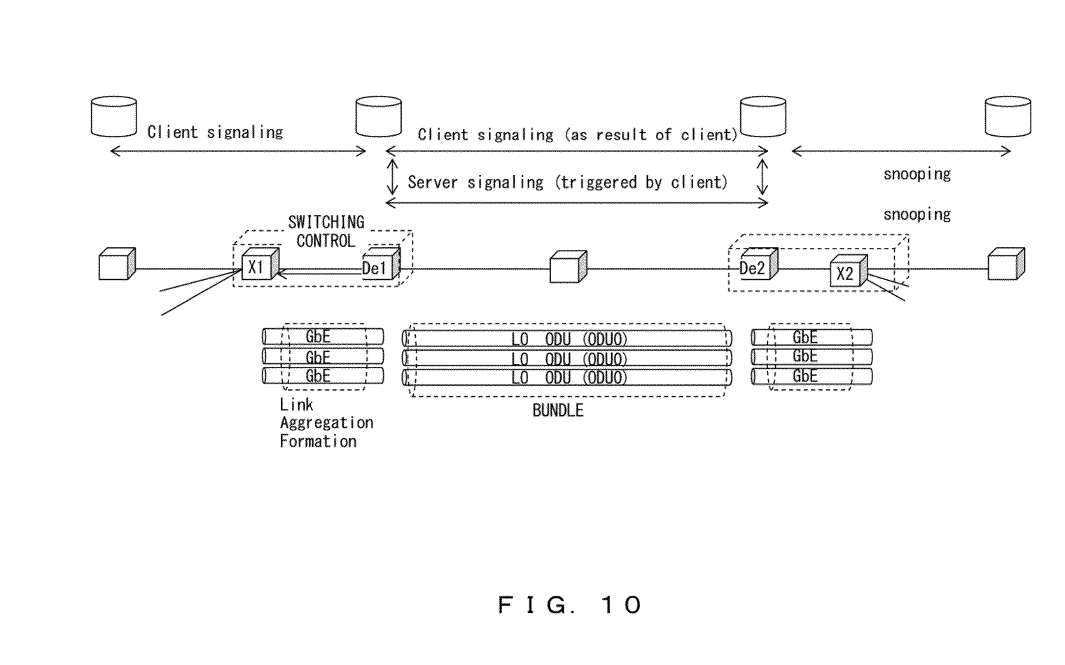

FIG. 10 illustrates another configuration example of the present embodiment.

The configuration assumes that reports are circulated in the system, that ODU0s are bundled between transmission devices De1 through De2 (set to be parallel, and handled as a single link), and that signaling is performed. Transmission device De1 performs Link Aggregation between switching device X and transmission devices De in response to the fact that ODU0s have been bundled, and the switching device X assumes that the aggregated links are output to the same output port, and manages an input/output table. The fact of the performance of this process is transmitted from transmission device De1, and that fact is set on table 2a in FIG. 7.

As a result of this, ODU0s remain unchanged, and accordingly links between switching device X and transmission devices De are equivalent to a result of a GbE receiving an aggregation (LAG) of n links. Because it has become a LAG, techniques of redundancy between links can be applied. Specifically, traffic can be concentrated only to i links out of n links.

If there are two links, the link used currently and the spare link, ITU-T G.8031 can also be applied as a redundancy technique.

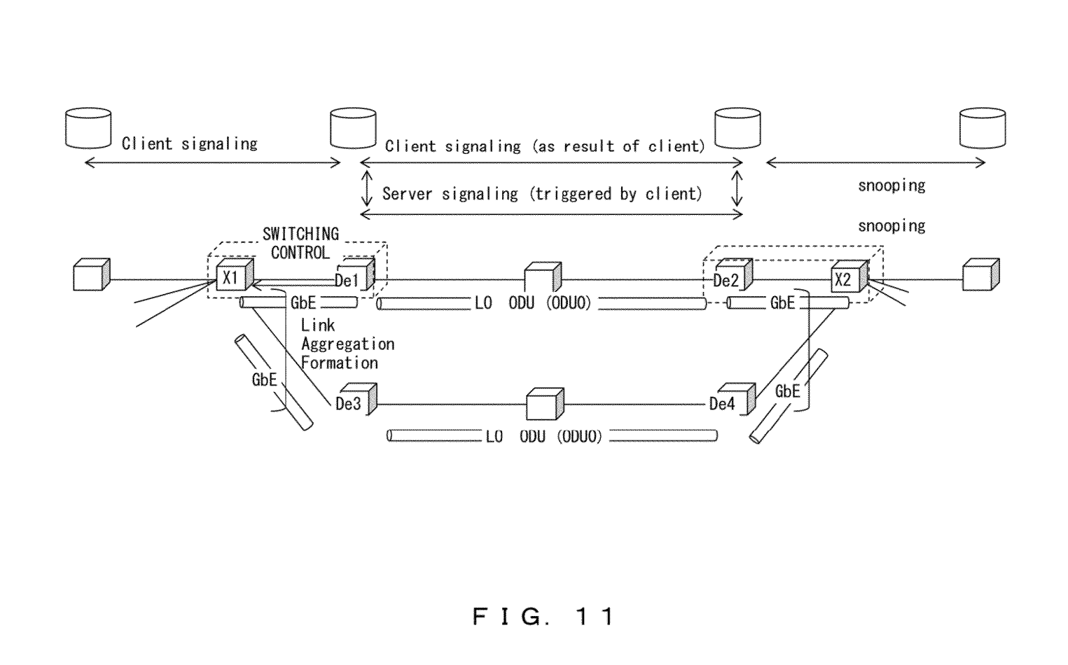

FIG. 11 illustrates still another configuration example of the present embodiment.

In addition to the constituents in FIG. 10, it is also possible to provide a GbE that has received a LAG between switching devices X1 and X2 as illustrated in FIG. 11.

However, switching device X is a device that is not compatible with GMPLS, and accordingly if there exists switching device X1, transmission device De3, transmission device De4, and switching device X2 when setting is to be performed, problems related to GMPLS occur on the control plane or the like, which requires a setting based on the following steps.

1) Links between X1 and De3, and between X2 and De4 are disconnected.
2) When a series of setting is performed between X1, De1, De2, and X2, a report of performing this setting is transmitted from De1 and De2 to De3 to De4, respectively. In other words, while setting a link between De1 and De2, a link between De3 and De4 is set. Specifically, When the signaling to the server layer (ODU) between De1 and De2 is triggered during the signaling of clients (X1-De1-De2-X2), an instruction is issued to perform the same signaling between De3 and De4 independently.
3) After the completion of the setting of X1 and X2, links between X1 and De3 and between X2 and de4 are activated, and setting is performed in De3 and De4 so that these links can map into the ODU.
4) Link Aggregation is set locally between X1 and X2 (perform LACP (Link Aggregation Control Protocol)). “Set locally” refers to connect ports between X1 and X2.

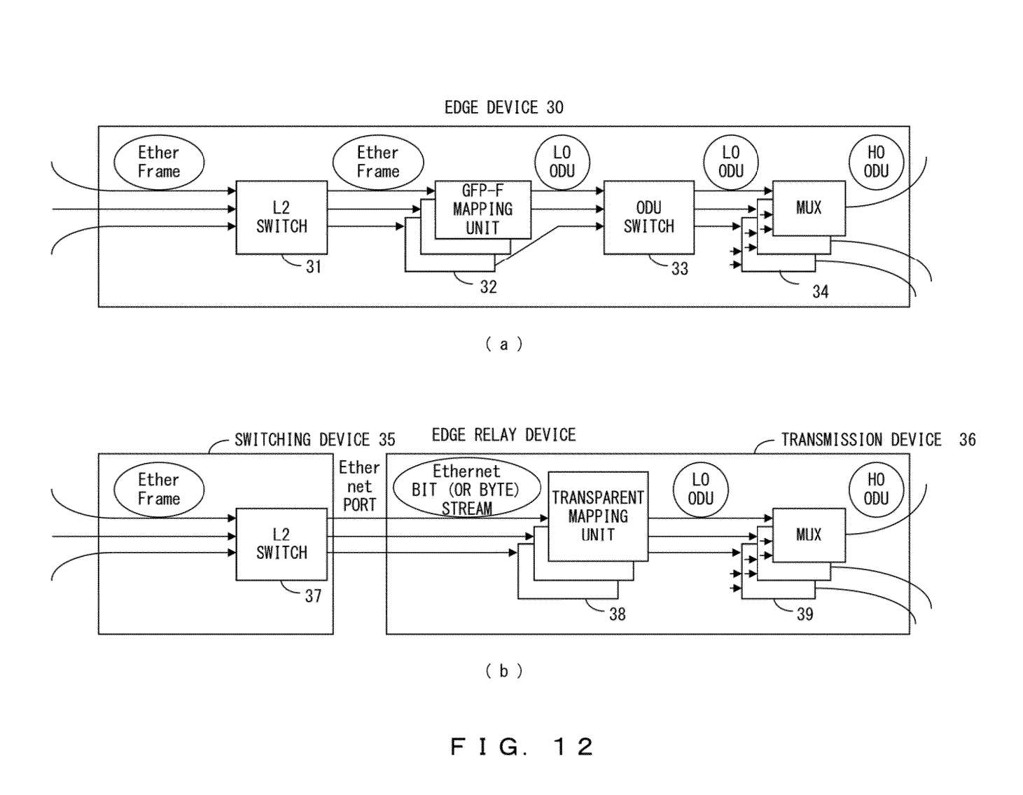

FIG. 12 illustrate a comparison between a conventional configuration and a configuration according to the present embodiment.

FIG. 12(a) illustrates a conventional configuration. In a conventional edge device 30, an L2 switch 31 performs, in accordance with an L2 ID, a switching process on a client signal such as an Ethernet signal input from the left side. An Etherframe output from the L2 switch 31 is mapped by a GFP-F mapping unit 32 into LO ODU in accordance with an L2 ID. A signal output from the GFP-F mapping unit 32 undergoes switching by an ODU switch 33 so that that signal is input to an MUX 34 of a corresponding HO ODU. The MUX 34 aggregates, into an HO ODU, the signal mapped into an LO ODU, and outputs the resultant signal.

FIG. 12(b) illustrates a configuration according to the present embodiment. In FIG. 12(b), a switching device 35 and a transmission device 36 constitute a function corresponding to a conventional edge device. A client signal is input to an L2 switch 37 of the switching device 35. The L2 switch 37 performs a switching process in accordance with the L2 ID so that the Etherframe of the client signal is output to an output port corresponding to the LO ODU. This L2 switch 37 includes the functions of the L2 determination unit 19 and the output destination determination unit 18 illustrated in FIG. 8. A signal output from the output port of the switching device 35 is input to a mapping unit 38 of the transmission device 36. This mapping unit 38 performs transparent mapping. In other words, this mapping is not a mapping of switching frames, but a mapping of including an input Etherframe to an LO ODU in units of bits or bytes, and transferring them as they are. The mapping unit 38 corresponds to the transparent mapping units 25-1 through 25-3 illustrated in FIG. 8. LO ODU signals output from the mapping unit 38 are aggregated into an HO ODU by the MUX 39, and are output. The MUX 39 corresponds to the ODU Mux 24 illustrated in FIG. 8, and performs aggregation in units of HO ODUs or wavelengths.

As has been described above, a conventional edge device requires a switching function both in an Ethernet and in ODUs, and also requires a large capacity, which depends upon the ODU capacity. By contrast, according to the present embodiment, the processing load of GFP-F is reduced on the stage of L2. Instead, ODU mapping in units of bits or bytes is realized for a signal input (received) from an Ethernet port. When an LO ODU is mapped transparently into an HO ODU, switching processes for accommodating a signal to LO/HO ODUs are not necessary (aggregation is enough), and the circuit scale can be reduced.

Also, a switching device itself is implemented by a conventional Ethernet switching technique, and signals are only exchanged in accordance with settings, and there are no impacts on hardware cost.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A switching device connected to a transmission device that aggregates lines on a client layer into lines on a server layer so as to transmit the aggregated lines, comprising:
a switching unit to switch a packet of the lines on the client layer to an output port to which each line on the server layer is associated, and to output the packet to the transmission device, in accordance with a line identifier of the line on the client layer.

2. The switching device according to claim 1, wherein:
the transmission device transparently maps, into the line on the server layer, a packet input through the output port.

3. The switching device according to claim 1, wherein:
a line on an upper layer is accommodated, as a physical port, to a lower layer on the assumption that the client layer is an upper layer and the server layer is a lower layer.

4. The switching device according to claim 1, wherein:
Ethernet defined by IEEE802.1 is applied as the client layer, and an OTN is applied as the server layer.

5. The switching device according to claim 1, wherein:
MPLS (Multi-Protocol Label Switching) is applied as the client layer, and an OTN is applied as the server layer.

6. The switching device according to claim 1, wherein:
when connections are bundled on a server layer, links between the transmission device and the switching device are bundled and managed.

7. An edge device system that aggregates lines on a client layer into lines on a server layer so as to transmit the aggregated lines, comprising:
a switching unit to switch and output a packet of the lines on the client layer to an output port to which each line on the server layer is associated, in accordance with a line identifier of the line on the client layer; and
a mapping unit to transparently map, into the line on the server layer, a packet input through the output port.
